(19) United States
(12) Patent Application Publication
(10) Pub. No.: US 2007/0246563 A1
(43) Pub. Date: Oct. 25, 2007

(54) Method for reducing drip from agricultural sprayer nozzles

(76) Inventor: Cameron Dwight Bodie, Moose Jaw (CA)

Correspondence Address: FROST BROWN TODD, LLC, 2200 PNC CENTER, 201 E. FIFTH STREET, CINCINNATI, OH, 45202, US

(21) Appl. No.: 11/739,940

(22) Filed: Apr. 25, 2007

Related U.S. Application Data
(63) Continuation-in-part of application No. 10/862,663, filed on Jun. 7, 2004, now abandoned.

(30) Foreign Application Priority Data
May 11, 2004 (CA) 2,466,874

(51) Int. Cl. B05D 1/02

(52) U.S. Cl. 239/11

(57) ABSTRACT

A method of reducing drip from nozzles mounted on a generally horizontally oriented supply conduit of an agricultural sprayer includes connecting the supply conduit to a source of pressurized liquid from the agricultural sprayer such that the liquid flows into an interior of the supply conduit, and venting air from the interior of the supply conduit as the pressurized liquid enters the interior of the supply conduit to reduce the amount of air remaining in the supply conduit when the nozzles are spraying liquid.

### RELATED APPLICATIONS

This application is a Continuation-in-Part of U.S. patent application Ser. No. 10/862,663, filed Jun. 7, 2004, entitled Method and Apparatus for Reducing Drip from Spray Nozzles. This application further claims priority to Canadian Serial No. 2,466,874, filed May 11, 2004.

### FIELD OF THE INVENTION

This invention is in the field of equipment for agricultural spraying of herbicides, pesticides, and the like and in particular addresses the problem of dripping nozzles on present agricultural sprayers.

### BACKGROUND OF THE INVENTION

Agricultural spraying equipment typically comprise a vehicle, either self-propelled or mounted on a cart towed by a tow vehicle, with a supply tank mounted thereon and a pump operative to deliver liquid from the tank to a generally horizontal supply conduit on a supporting boom with nozzles mounted thereon. Agricultural sprayers are typically either wet boom or dry boom sprayers. In a wet boom sprayer, the horizontal boom is a rigid hollow pipe with the nozzles mounted directly to the pipe, and the pipe performs the function of the supply conduit. In a dry boom sprayer, the horizontal boom is a rigid boom member and the nozzles are mounted on the boom member. A hose or like conduit is connected to each nozzle, or from one nozzle to the next, to supply liquid to the nozzles.

In either a wet or dry boom type sprayer, liquid is pumped into the conduit from the supply and passes through the supply conduit to the nozzles. Typically controls include a boom valve that directs the output of a pressurized liquid source, typically the liquid output of a pump, either into the supply conduit to commence the spraying operation when in an on position, or into a return line back to the sprayer tank to cease spraying when in an off position.

It is desirable in agricultural spraying applications to have the nozzles stop spraying as soon as the boom valve is turned to the off position. Dripping nozzles cause crop damage and waste costly agricultural chemicals. Conventionally the problem of dripping valves has been addressed by including a drip valve in each nozzle.

A minimum opening pressure must be present in the conduit before the drip valve opens and liquid can reach the nozzle and be sprayed. The conduits can be quite lengthy and so the drip valves prevent liquid from running out of those nozzles closest to the liquid input end of the conduit before liquid reaches the distal end of the conduit farthest from the input. Further, in order for the nozzles to achieve a satisfactory spray pattern for even coverage of the surface to be sprayed, at least some liquid pressure must be present in the conduit, and during spraying the pressure is maintained generally at some desired operating pressure higher than the opening pressure.

Thus when the boom valve is operated to direct liquid into the supply conduit to initiate spraying, liquid flows into the conduit from the input end toward the distal end and pressure starts to build up in the conduit. When the opening pressure is reached, the drip valves open and the nozzles begin to spray. Some of the air that is present in the conduit may be expelled through some nozzles where the intake is not covered by water when the opening pressure for the drip valve is reached. The pressure however fairly quickly builds up to the desired operating pressure and liquid covers the outputs to all the nozzles and the liquid is sprayed from all nozzles.

When the boom valve is operated to cease spraying, liquid flow into the conduit stops, and the pressure in the conduit drops as liquid already present in the conduit leaves through the nozzles. When the pressure in the conduit drops to the opening pressure the drip valves close, and liquid flow out the nozzles stops.

A problem with current drip valves is that they are set at an opening pressure that is significantly below the typical operating pressures. For example the opening pressure is typically about 12 pounds per square inch (psi), while the operating pressure is typically about 40 psi or higher. Thus the drip valves remain open and liquid passes through the nozzles until the pressure in the supply conduit drops from 40 psi to 12 psi. Setting the opening pressure at a level closer to the typical operating pressure is problematic, because in some situations low pressure spraying is desired, and would not be possible if the opening pressure of the drip valves was higher than the desired low operating pressure.

The problem of dripping nozzles is also addressed in prior art agricultural sprayers where, instead of a boom valve controlling flow to the conduit and drip valves at each nozzle, individually controlled nozzle valves are incorporated into the nozzle body that attaches each nozzle to the boom. The operating pressure is then present in the supply conduit at all times, and flow to the nozzles is directly controlled by the nozzle valves. Such individual nozzle valves overcome the dripping problem of conventional nozzles by providing substantially instant spray on and spray off, however the cost for incorporating and maintaining such a system is significantly higher than the conventional boom valve.

### SUMMARY OF THE INVENTION

It is an object of the present invention to provide an agricultural spraying method that overcomes problems in the prior art.

The present inventor has recognized that air trapped in the supply conduit is pressurized to the operating pressure and when the supply is turned off, the compressed air maintains the pressure in the supply conduit at the operating pressure and pushes liquid out through the nozzles until the air has expanded sufficiently that the pressure of the compressed air is below the opening pressure of the drip valves. The present invention therefore provides a method of agricultural spraying that reduces the amount of air in the supply conduit carrying liquid to the spray nozzles.

The present invention provides a method of reducing drip from nozzles mounted on a generally horizontally oriented supply conduit of an agricultural sprayer. The method comprises connecting the supply conduit to a source of pressurized liquid from the agricultural sprayer such that the liquid flows into an interior of the supply conduit; and venting air from the interior of the supply conduit as the pressurized liquid enters the interior of the supply conduit to reduce the amount of air remaining in the supply conduit when the nozzles are spraying liquid.

An extension can be added to the nozzle conduit such that as the liquid rises in the supply conduit it pushes air out through the top end of the extension, located in an upper portion of the supply conduit, and then out through the nozzle. Liquid does not flow out of the nozzle until the liquid level reaches the top end of the extension after most of the air in the supply conduit has been pushed out.

In prior art spraying systems, the nozzle conduit connecting the nozzle to the supply conduit has an input end at the bottom of the supply conduit. As liquid enters the supply conduit to commence spraying it almost immediately covers the input ends of the nozzle conduits, and traps the air present in the supply conduit. Typically such systems include a drip valve in the nozzle conduit, such that flow out through the nozzles is prevented until the pressure in the supply conduit rises to an opening pressure of the drip valves. Liquid then begins to flow through the nozzles, and the pressure in the supply conduit rises to the operating pressure. The trapped air is thus compressed to the operating pressure.

When the liquid flow into the supply conduit is shut off to stop spraying, while no further liquid enters the supply conduit, pressure is maintained therein by the large volume of compressed trapped air. The pressure exerts a force on the liquid left in the supply conduit and forces it out through the nozzles such that the nozzles drip for a significant period of time after it is desired to stop spraying until the pressure of the compressed air drops to a point where the drip valves close. By reducing the volume of air trapped in the supply conduit, the volume of compressed air is reduced and thus much less liquid must leave the supply conduit by dripping from the nozzles in order to reduce the pressure of the trapped air, and the nozzles drip for a reduced time.

Conveniently the amount of air remaining in the supply conduit can be reduced by drawing liquid from an upper portion of the supply conduit to supply the nozzle. An apparatus for practicing the method comprises a nozzle secured at the output end of a nozzle conduit wherein the input end of the nozzle conduit is located in an upper portion of the supply conduit. When liquid enters the supply conduit, it must rise to the upper portion of the supply conduit before it can flow through the nozzle conduit to the nozzle. As it rises it pushes air above it out through the nozzle conduits and nozzles, and so the supply conduit when operating is substantially filled with liquid rather than containing a large portion of compressed air as in the prior art.

Alternatively the nozzle body could be connected to the top of the supply conduit, rather than conventionally being connected to the bottom thereof. The nozzle conduit could thus be oriented so that it enters the top of the supply conduit, rather than conventionally being attached to the bottom thereof. Alternatively again, a vent could be supplied to vent air from the supply conduit when liquid enters the supply conduit to commence spraying.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic front view of a spraying apparatus for practicing the method of the invention;

FIGS. 2 and 3 are a schematic cross-sectional view along lines 2-2 in FIG. 1 showing a nozzle body apparatus of the invention mounted on a supply conduit;

FIGS. 4 and 5 are a schematic cross-sectional views showing a nozzle body apparatus of the prior art mounted on a supply conduit;

FIG. 6A is a schematic cross-sectional view of a nozzle body with a drip valve positioned in the nozzle conduit, and shown in a closed position;

FIG. 6B is a schematic cross-sectional view of the drip valve of FIG. 6A shown in an open position;

FIGS. 7 and 8 are a schematic cross-sectional view along lines 2-2 in FIG. 1 showing a nozzle body apparatus of the invention mounted on a supply conduit with a drip valve positioned in the nozzle conduit;

FIGS. 9 and 10 are a schematic cross-sectional views showing a nozzle body apparatus of the prior art mounted on a supply conduit with a drip valve positioned in the nozzle conduit;

FIG. 11 is a schematic cross-sectional view of an alternate arrangement of the nozzle body and nozzle conduit showing connection to a top of the supply conduit;

FIG. 12 is a schematic front view of an alternate apparatus for practicing the method of the invention showing a vent valve;

FIG. 13 is a schematic cross-sectional view of the vent valve of FIG. 12;

FIG. 14 is a schematic top view of an agricultural sprayer for practicing the method of the invention.

### DETAILED DESCRIPTION OF ILLUSTRATED EMBODIMENTS

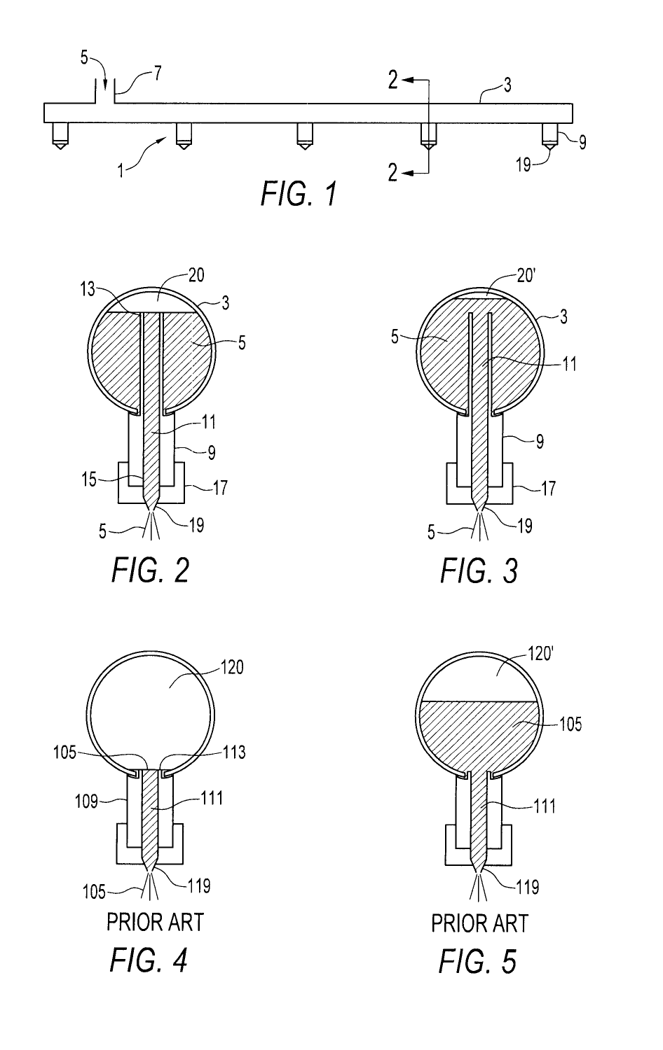

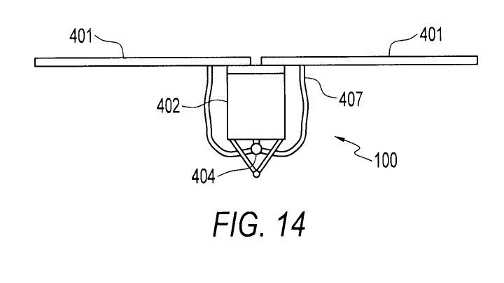

FIGS. 1-3 schematically illustrate a nozzle and supply conduit apparatus 1 for installation on an agricultural sprayer 100, as illustrated in FIG. 14, for practicing the method of the invention. The apparatus 1 comprises a generally horizontally oriented supply conduit 3 carrying pressurized liquid 5 that is pumped into the supply conduit through the inlet 7 from a pump on the agricultural sprayer. A nozzle body 9 is attached to the supply conduit 3 over an aperture through the supply conduit 3 by clamps, by screwing into a threaded aperture in the supply conduit 3, or like means as are well known in the art such that the nozzle body 9 is in sealed communication with the supply conduit 3.

A nozzle conduit 11 extends through the nozzle body 9. The nozzle conduit 9 has an input end 13 located inside the supply conduit 3 in an upper portion of the supply conduit 3 as illustrated in FIGS. 2 and 3, and an output end 15 at a lower end 17 of the nozzle body 9. A nozzle 19 is secured in a lower end 17 of the nozzle body 9 at the output end 15 of the nozzle conduit 11 such that pressurized liquid in the upper portion of the supply conduit 3 can enter the input end 13 of the nozzle conduit 11 and flow through the nozzle conduit 11 to the output end 15 thereof and then out through the nozzle 19.

The lower portion of the nozzle conduit 11 is defined by the nozzle body 9, and an upper portion of the nozzle conduit 11 can comprise a nozzle conduit extension attached to the nozzle body 9 by fitting it into the top end of the nozzle conduit 11 on a prior art nozzle body such that the nozzle conduit extension extends into the supply conduit 3. Conveniently the nozzle body 9 can also be configured such that an upper portion of the nozzle body 9 defining the nozzle conduit 11 extends into the upper portion of the supply conduit 3 when the nozzle body 9 is attached to the supply conduit 3.

In any event the apparatus provides a vent operative to allow air inside the supply conduit to vent to the atmosphere as liquid enters the interior of the supply conduit when the pressurized liquid source is connected. As the liquid enters it flows along the bottom of the supply conduit 3 and as it rises in the conduit 3 the air above the liquid is forced into the input end 13 of the nozzle conduit 11 at the top of the supply conduit 3 and is pushed out through the nozzle 19. The amount of air 20 remaining in the supply conduit 3 when the nozzles 19 are spraying liquid is reduced. In the illustrates embodiment of FIGS. 2 and 3, the amount of air 20 remaining in the supply conduit 3 is reduced by drawing liquid from an upper portion of the supply conduit 3 to supply the nozzle 19. The vent is here provided by proper orientation of the input end 13 of the nozzle conduit 11 at the top of the supply conduit 3 such that air is pushed out through the nozzle 19 as the liquid 5 rises.

FIG. 2 illustrates the apparatus of the invention and shows that the level of liquid 5 in the supply conduit must rise up into the upper portion of the supply conduit 3 before the liquid 5 can enter the input end 13 of the nozzle conduit 11. Thus when pressurized liquid 5 is directed into the intake 7 of the supply conduit 3 by a sprayer control (not shown), the level of liquid 5 in the supply conduit 3 rises, pushing air that is present in the supply conduit into the input end 13 of the nozzle conduit 11 and out through the nozzle 19. When the liquid 5 rises above the input end 13 of the nozzle conduit 11, the liquid 5 begins to flow out through the nozzle 19.

Once the liquid rises to the level of the input end 13 of the nozzle conduit 11 and begins to flow out of the nozzle 19, the liquid 5 blocks the input end 13 of the nozzle conduit 11 and the air 20 remaining in the supply conduit 3 above the liquid 5 is trapped and compressed as the liquid rises in the supply conduit 3 to the level of FIG. 3, at which point the pressure in the supply conduit is equal to the operating pressure. FIG. 3 illustrates the trapped air 20′ compressed at the operating pressure and occupying a small volume of the supply conduit 3. The closer the input end 13 of the nozzle conduit 11 is to the top of the supply conduit 3, the smaller the volume of air that will be trapped and compressed in the supply conduit 3.

A schematic cross-sectional view of a prior art supply conduit 103 and nozzle body 109 is shown in FIGS. 4 and 5. In contrast to the apparatus of the invention described above, the nozzle conduit 111 of the prior art has the input end 113 of the nozzle conduit 111 located in a lower portion of the supply conduit 103.

Some prior art nozzle conduits are mounted such that the input end is near the middle of the supply conduit with the nozzle body extending frontwards or rearwards. These configurations have been used to provide a horizontal orientation to the nozzle body that is more favorable to mounting a plurality of nozzles on a turret for quick change from one nozzle size to another. The illustrated prior art shows the input end 113 of the nozzle conduit 111 at the bottom of the supply conduit 103, as is more typically the case.

In FIG. 4 it can be seen that when liquid 105 starts to flow into the supply conduit 103, it almost immediately starts to flow into the input end 113 of the nozzle conduit 111 and out through the nozzle 119, and air 120 above the input end 113 of the nozzle conduit 111 is trapped. Thus the supply conduit 103 is substantially full of trapped air 120 that is compressed as the pressure rises to the operating pressure. FIG. 5 illustrates the trapped air 120′ compressed at the operating pressure and occupying a substantial volume of the supply conduit 3.

The supply conduit 3, 103 in both cases thus forms a compressed air reservoir containing a much smaller volume of compressed air 20′ in the supply conduit 3 of the invention, as seen in FIG. 3, compared to the volume of compressed air 120′ in the prior art supply conduit 103 as seen in FIG. 5.

In either case, when the sprayer control is operated to close off the supply of pressurized liquid 5, 105, no further liquid enters but pressure is still exerted in the supply conduit 3, 103 by the compressed trapped air 20′, 120′ which exerts a force on the surface of the liquid 5, 105 that continues to force liquid out through the nozzles 19, 119.

The pressure in the supply conduits 3, 103 drops as liquid 5, 105 flows out of the nozzles 19, 119. The force exerted on the surface of the liquid 5, 105 by the trapped air 20′, 120′ decreases as the liquid 5, 105 flows out the nozzles 19, 119, until the liquid level drops to the level of FIGS. 2 and 4 respectively, when the pressure exerted is back to original atmospheric pressure, as it was when the air was first trapped by liquid blocking the input end 13, 113 of the nozzle conduit 11, 111.

Thus it can be seen that much more liquid 105 must pass out of the nozzles 119 of the prior art system of FIGS. 4 and 5 than in the Applicant's system of FIGS. 2 and 3 before the air ceases to exert pressure pushing the liquid out of the nozzles. Thus the system of the present invention reduces the amount of liquid that drips out of the nozzle after the pressurized liquid source is disconnected from the supply conduit, and thus reduces the length of time that the nozzles drip.

It will be recognized that where the input end of the nozzle conduit is located in the middle of the supply conduit, as in some of the prior art, while a somewhat smaller amount of air is trapped in the supply conduit, the same problems will occur.

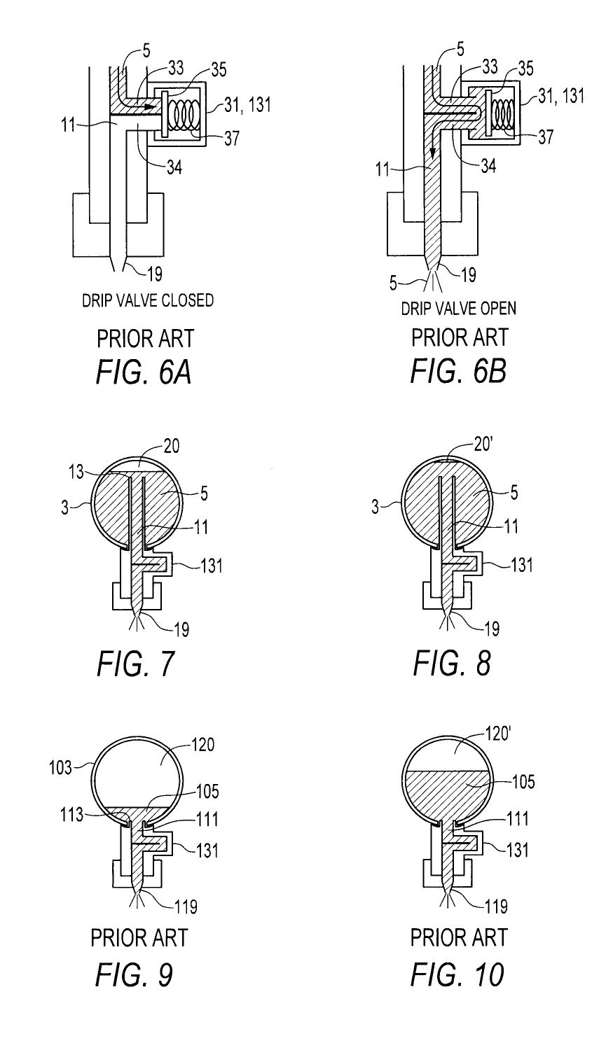

The nozzle conduits 11, 111 of FIGS. 2-5 have been illustrated without a drip valve 31 such as that illustrated in FIGS. 6A and 6B. Such open nozzle conduits 11, 111 are not generally suitable for agricultural spraying machines, since as the machine travels the liquid will slosh back and forth. In the prior art agricultural sprayers, essentially all the liquid 105 will drain out of the supply conduit 103 through the nozzles, which will only quit dripping when the supply conduit 103 is empty.

This dripping problem in agricultural sprayers is reduced in the system of the present invention, since much less liquid 5 will drain out of the supply conduit 3 even when moving across the ground with the liquid 5 sloshing back and forth. Liquid will however continue to drip out of the nozzles 19 from time to time, and so it is desirable to position a drip valve 31 in the nozzle conduit 11. The drip valve 31, 131 illustrated in FIGS. 6A and 6B is one commonly used in agricultural sprayers to prevent nozzle drip, and other drip valve mechanisms are known in the art as well. The nozzle conduit 11 comprises a pair of parallel passageways 33, 34. A coil spring 37 exerts a bias force on a seal 35 such that the seal 35 pushes against the ends of the parallel passageways 33, 34 and thus blocks the nozzle conduit 11 to prevent liquid 5 from passing through the nozzle conduit 11 to the nozzle 19.

When liquid present in the nozzle conduit 11 rises to an opening pressure, the liquid pushes the seal 35 against the bias force of the spring 37, and allows the liquid 5 to flow through the end of the top passageway 33 and into the end of the bottom passageway 34, and out through the nozzle 19. Thus liquid at a liquid pressure less than the opening pressure is prevented from passing through the nozzle conduit 11 from the input end thereof to the nozzle 19, and liquid at a liquid pressure greater than the opening pressure passes through the nozzle conduit 11 and out the nozzle 19.

FIGS. 7 and 8 illustrate the operation of the present invention in a system including a drip valve 31 positioned in the nozzle conduit 11. Instead of passing through the nozzle conduit 11 to the nozzle 19 and beginning to spray as soon as the level of the pressurized liquid 5 reaches the input end 13 of the nozzle conduit 11 as in the embodiment of FIG. 2, the pressure in the supply conduit 3 and nozzle conduit 11 must rise to the opening pressure of the drip valve 31, and so the level of the liquid 5 is well above the input end 13 of the nozzle conduit 11 before liquid 5 can begin to flow to the nozzle 19, as illustrated in FIG. 7. The level of the liquid 5 at the operating pressure is illustrated in FIG. 8, and is substantially the same as that of FIG. 3 where there is no drip valve.

Similarly FIGS. 9 and 10 illustrate the operation of the prior art system including a drip valve 131 positioned in the nozzle conduit 111. Here as well the pressure in the supply conduit 103 and nozzle conduit 111 must rise to the opening pressure of the drip valve 131, and so the level of the liquid 105 is well above the input end 113 of the nozzle conduit 111 before liquid 105 can begin to flow to the nozzle 119, as illustrated in FIG. 9. The level of the liquid 105 at the operating pressure is illustrated in FIG. 10, and is substantially the same as that of FIG. 5 where there is no drip valve.

The drip valves 31, 131 function to prevent flow through the nozzles 19, 119 until the opening pressure has been attained in the supply conduit 3, 103. The initial spray pattern is improved, since the nozzles 19, 119 are operating at the opening pressure instead of at essentially zero pressure as is the case where no drip valve is present. Also liquid generally is present at all nozzle locations along the supply conduit 3, 103 and so the nozzles 19, 119 tend to start spraying together, rather than those nearest the input 7 starting to spray first.

As in the apparatuses of FIGS. 2-5, when the sprayer control is operated to close off the supply of pressurized liquid 5, 105, the pressure in the supply conduits 3, 103 drops as liquid 5, 105 flows out of the nozzles 19, 119. The force exerted on the surface of the liquid 5, 105 by the trapped air 20′, 120′ decreases as the liquid 5, 105 flows out the nozzles 19, 119, until the pressure in the supply conduit 3, 103 and nozzle conduit 11, 111 drops to the opening pressure of the drip valve 31, 131 and the liquid level drops to the level of FIGS. 7 and 9. The drip valves 31, 131 then close.

Again, very much less liquid is forced out of the nozzles 19 in the apparatus of the invention illustrated in FIGS. 7 and 8, and thus the time the nozzle drips is reduced.

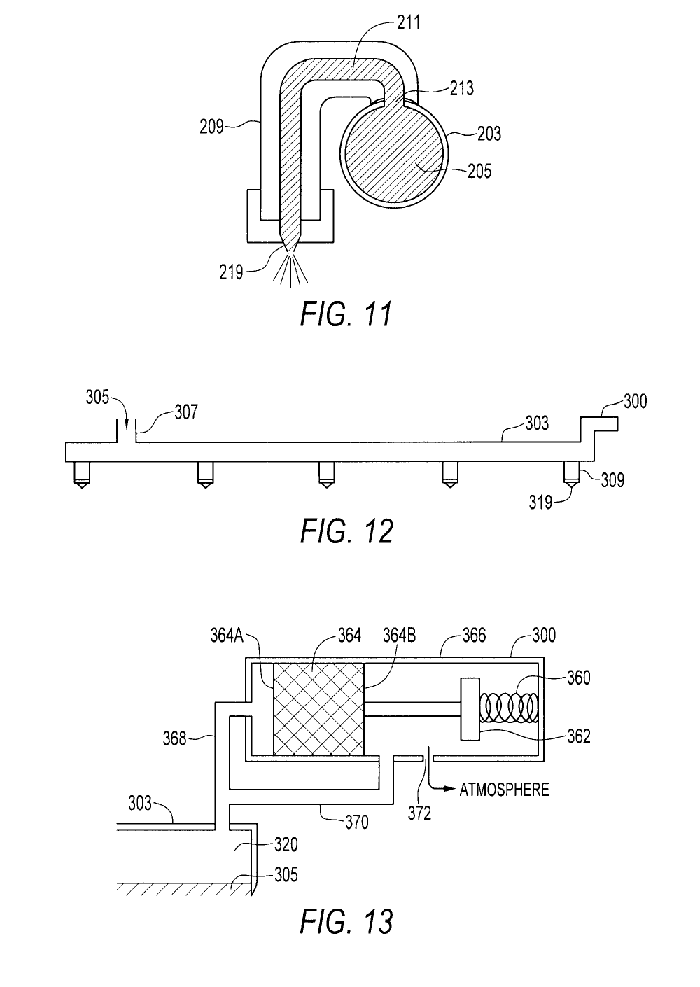

FIG. 11 illustrates an alternate embodiment of the invention wherein the nozzle conduit 211 is also defined by the nozzle body 209, but in this case the nozzle body 209 extends into the supply conduit 203 through an aperture on a top of the supply conduit 203, instead of the bottom as illustrated above. Again the vent is provided by orienting the input end 213 of the nozzle conduit 211 at the very top of the supply conduit 203, such that substantially all air in the supply conduit 203 is forced out through the nozzle conduit 211 and nozzle 219, leaving virtually no air to be trapped and compressed, causing nozzle drip. The supply conduit 203 is substantially filled with liquid 205. A drip valve could also be incorporated into the nozzle conduit 211 to prevent drip from liquid 205 sloshing back and forth during travel when spraying is turned off.

The embodiments of FIGS. 2, 3, 7, and 8 can readily be provided by using a nozzle conduit extension and the common bottom holes provided in typical conventional sprayers. Thus same can be retrofit to existing machines. The embodiment of FIG. 11 could be implemented by modifying the nozzle body 209 to mount on the top of the supply conduit 203, with the nozzle 219 oriented to spray down.

FIGS. 12 and 13 illustrates an alternate embodiment of the invention wherein one or more separate vent valves 300 are provided to vent air 320 from the supply conduit to the atmosphere as the liquid 305 rises in the supply conduit 303. The vent valve 300 is connected to a top portion of the supply conduit 303 and is operative to open and vent air 320 from the supply conduit 303 when the pressure in the supply conduit 303 is below a venting pressure, and is operative to close when the pressure in the supply conduit 303 rises to the venting pressure.

FIG. 13 illustrates one embodiment of a venting valve 300 suitable to provide the required function. A spring 360 exerts a force on a plunger 362 connected to a piston 364 sliding in a cylinder 366. A pressure line 368 connects the interior of the cylinder 366 on the pressure side 364A of the piston 364 to the interior of the supply conduit 303. A vent line 370 also connects the interior of the cylinder 366 on the spring side 364B of the piston 364 to the interior of the supply conduit 303. A vent hole 372 in the wall of the cylinder 336 connects to the atmosphere. When pressure in the supply conduit 303 is below the venting pressure, the spring 360 forces the piston 364 to the left, such that the vent line 370 is open through the vent hole 372 to the atmosphere as illustrated in FIG. 13. As the liquid 305 and pressure in the supply conduit 303 rises, air 320 is vented to the atmosphere through the vent line 370 and vent hole 372. As the pressure in the supply conduit 303 rises, the piston 364 is forced to the right against the force of the spring 360. When the pressure in the supply conduit 303 rises to the venting pressure, the piston 364 has moved to the right far enough to block the entrance of the vent line 370 into the cylinder 366. No further air 320 or liquid 305 can escape, and pressure in the supply conduit 303 rises to the operating pressure during spraying.

A problem with the embodiment of FIGS. 12 and 13 is that some liquid will also be vented as the pressure builds when the supply conduit 303 is not oriented horizontally. FIG. 14 illustrates an agricultural sprayer 100 with a liquid tank 402 and a pump 404 operative to pump liquid under pressure from the tank 404 into the inlet 407 of the nozzle and supply conduit apparatuses 401 extending laterally from each side of the sprayer 100. The illustrated sprayer 100 is configured to be towed by a towing vehicle in an operating travel direction T. Other agricultural sprayers are well known where the spraying apparatus is mounted on a self propelled vehicle and the method of the present invention will work equally well on such sprayers.

The method and apparatus of the invention reduces drip from the nozzle 19 by venting air from the interior of the supply conduit 3 as the pressurized liquid enters the interior of the supply conduit 3 and thereby reducing the amount of air 20 remaining in the supply conduit 3 when the nozzles 19 are spraying liquid.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A method of reducing drip from nozzles mounted on a generally horizontally oriented supply conduit of an agricultural sprayer, the method comprising:
connecting the supply conduit to a source of pressurized liquid from the agricultural sprayer such that the liquid flows into an interior of the supply conduit;
venting air from the interior of the supply conduit as the pressurized liquid enters the interior of the supply conduit to reduce the amount of air remaining in the supply conduit when the nozzles are spraying liquid.

2. The method of claim 1 comprising providing a nozzle conduit connecting the supply conduit to the nozzle, and locating an input end of the nozzle conduit in an upper portion of the supply conduit such that as liquid enters the lower portion of the supply conduit, air is pushed into the input end of the nozzle and out through the nozzle.

3. The method of claim 2 further comprising providing a drip valve in the nozzle conduit such that liquid at a liquid pressure less than an opening pressure is prevented from passing through the nozzle conduit from the input end thereof to the nozzle, and liquid at a liquid pressure greater than the opening pressure passes through the nozzle conduit and out the nozzle.

4. The method of claim 1 wherein the air is vented by providing at least one vent valve connected to a top portion of the supply conduit at a location removed from the input of the supply conduit, and operative to open and vent air from the supply conduit when an operating pressure in the supply conduit is below a venting pressure, and operative to close when the operating pressure in the supply conduit rises to the venting pressure.

5. The method of claim 4 further comprising providing a drip valve in a nozzle intake such that liquid at a liquid pressure less than an opening pressure is prevented from passing through the nozzle intake to the nozzle, and liquid at a liquid pressure greater than the opening pressure passes through the nozzle intake and out the nozzle.
